(19) United States
(12) Patent Application Publication
(10) Pub. No.: US 2018/0096708 A1
(43) Pub. Date: Apr. 5, 2018

(54) VIDEO EDITING SYSTEM AND METHOD

(71) Applicant: Jocoos Co., Ltd., Seoul (KR)

(72) Inventors: Chang Hoon CHOI, Seoul (KR); Yoon Soo Lee, Seongnam-si (KR)

(21) Appl. No.: 15/335,439

(22) Filed: Oct. 27, 2016

(30) Foreign Application Priority Data
Sep. 30, 2016 (KR) 10-2016-0126389

(51) Int. Cl. G11B 27/036; H04L 29/06; H04N 21/422; H04N 5/265; G11B 27/34

(52) U.S. Cl. CPC G11B 27/036; H04L 65/602; G11B 27/34; H04N 5/265; H04N 21/42207

(57) ABSTRACT

A video editing system is provided. The video editing system according to one embodiment of the present invention includes a second server configured to transmit editing information, which corresponds to video information provided from a first server to a client terminal, to the client terminal, wherein the editing information is applied to the video information in the client terminal.

### RELATED APPLICATION

This application claims the benefit of priority of Korean Patent Application No. 10-2016-0126389 filed on Sep. 30, 2016, the contents of which are incorporated herein by reference in their entirety.

### FIELD AND BACKGROUND OF THE INVENTION

The present invention relates to a video editing system and a video editing method.

Generally, in broadcasting, video and audio data are transmitted in the form of radio waves mostly to unspecified individuals. Such form of broadcasting includes generation and transmission of a video and video relay, and various types of broadcasting, such as public broadcasting, cable TV broadcasting, general programming broadcasting, and the like, are available. In general, the majority of the broadcasting is provided by large companies that create and transmit media.

However, with the recent improvement of the Internet network environment, personal Internet broadcasting using network means has become more popular. Generally, individuals make videos using general computer terminals thereof or generate video files for broadcasting to be reproduced in user terminals, such as computers, and transmit the video or the video files.

In addition, besides the personal Internet broadcasting, video and video files on various online video platforms are also provided to the user terminals.

Users who provide broadcasting offer desired video information to many and unspecified persons by utilizing multimedia techniques and try to build consensus-communities based thereon.

Regarding the multimedia techniques, in order to provide viewers with a video with various editing effects applied, encoding has to be performed each time the video is edited. Thus, an editing result becomes very static.

### SUMMARY OF THE INVENTION

The present invention is directed to a video editing system and method for providing an edited video to a client without encoding.

According to an aspect of the present invention, there is provided a video editing system including a second server configured to transmit editing information, which corresponds to video information provided from a first server to a client terminal, to the client terminal, wherein the editing information is applied to the video information in the client terminal.

The editing information may be driven by OpenGL in the client terminal and a synthesized video in which the editing information is applied to the video information may be generated in the client terminal.

The video information and the editing information may be provided from either the first server or the second server to the client terminal without encoding.

The video editing system may further include a user terminal configured to provide the editing information.

The second server may include an interface unit configured to provide a user terminal with video selection information for editing the video information.

The video selection information provided from the second server to the user terminal for editing a video to be customized as desired by a user comprises at least one of a video selection screen, effect application screen, a preview screen, and a video timeline editing screen.

The video timeline editing screen may display a timeline of the video information.

Effects selected in the effect application screen may be applied to the timeline of the video information.

The selected effects may be sequentially applied according to the timeline of the video information.

The second server may further include an editing information generator configured to generate editing information corresponding to the video selection information selected through the interface unit and a database configured to store the video selection information.

The editing information generator may include a video timeline transmitter configured to provide first editing information about an order of video selection information and an editing unit configured to provide second editing information about an effect of the video selection information.

The second editing information in the editing unit may gradually apply the video selection information to the video information.

The second editing information in the editing unit may insert the video information into a predetermined video.

The video information may include visually recognizable data.

The editing information may be applied to the video information in real time.

According to another aspect of the present invention, there is provided a video editing method including: receiving, at a second server, editing information corresponding to video information provided from a first server to a client terminal; transmitting the editing information to the client terminal; and generating, at the client terminal, a synthesized video in which the editing information is applied to the video information.

The editing information may be driven by OpenGL in the client terminal and the synthesized video in which the editing information is applied to the video information may be generated in the client terminal.

The video information and the editing information may be provided from either the first server or the second server to the client terminal without encoding.

The video information may include visually recognizable data.

The editing information may be applied to the video information in real time.

### BRIEF DESCRIPTION OF THE SEVERAL VIEWS OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating a video editing system according to one embodiment of the present invention;

FIG. 2 is a block diagram illustrating a second server of the video editing system according to one embodiment of the present invention;

FIG. 3 is a diagram illustrating an interface of the video editing system in accordance with one embodiment of the present invention;

FIG. 4 is a block diagram illustrating an editing information generator of the video editing system according to one embodiment of the present invention;

FIG. 5 is a diagram illustrating a timeline according to which the video editing system in accordance with the embodiment of the present invention provides a viewer with different editing effects; and

FIG. 6 is a flowchart illustrating a video editing method according to one embodiment of the present invention.

### DESCRIPTION OF SPECIFIC EMBODIMENTS OF THE INVENTION

The following description of exemplary embodiments is provided to assist in gaining a comprehensive understanding of the methods, apparatuses, and/or systems described herein. Accordingly, various changes, modifications, and equivalents of the methods, apparatuses, and/or systems described herein will be suggested to those of ordinary skill in the art, and should not be construed in a limiting sense.

It will be understood that, although the terms first, second, etc. may be used herein to describe various elements, these elements should not be limited by these terms. These terms are only used to distinguish one element from another. For example, a first portion could be termed a second portion, and, similarly, a second portion could be termed a first portion without departing from the teachings of the disclosure.

It will be understood that when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present. As used herein, the term “and/or” includes any and all combinations of one or more of the associated listed items.

The terminology used herein is for describing particular example embodiments only and is not intended to be necessarily limiting of the present disclosure. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having meaning that is consistent with their meaning in the context of the relevant art and will not be interpreted in an idealized or overly formal sense unless expressly so defined herein.

Hereinafter, the present invention now will be described fully hereinafter with reference to the accompanying figures, in which the same drawing reference numerals are understood to refer to the same or equivalent elements, and redundant descriptions of the same elements will be omitted.

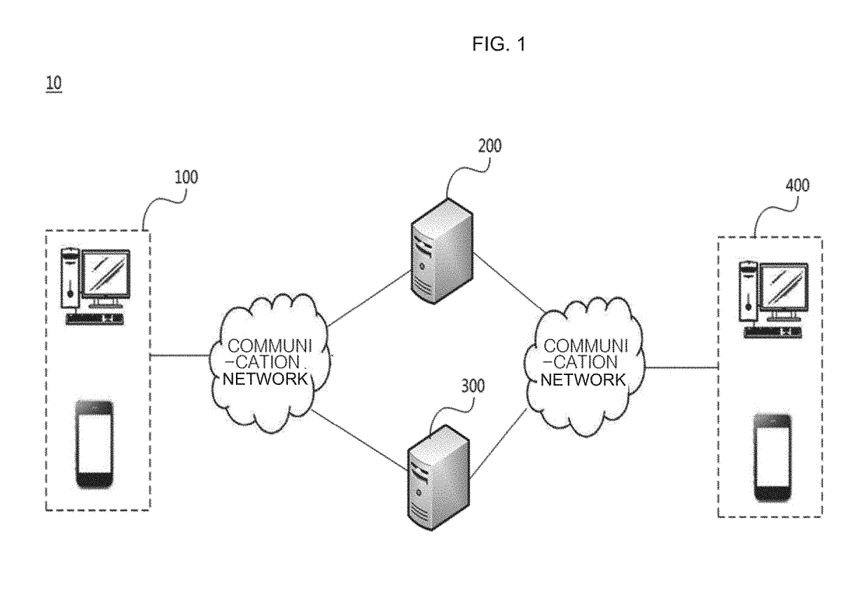

FIG. 1 is a block diagram illustrating a video editing system according to one embodiment of the present invention.

Referring to FIG. 1, the video editing system 10 includes a user terminal 100 which selects editing information for a video to be provided to a plurality of viewers, a first server 200 which provides video information to a client terminal 400, a second server 300 which provides the client terminal 400 with editing information selected by a user, and the client terminal 400 which provides the viewers with video information to which the editing information selected by the user is applied.

For example, the user terminal 100 may be applied to various types of mobile devices including a smartphone, a tablet computer, a laptop computer, a personal digital assistant (PDA), an electronic frame, a desktop personal computer (PC), a digital TV, a camera, and a wearable device such as a wristwatch and a head-mounted display (HMD).

However, the user terminal 100 is not limited to the above examples, and the user terminal 100 may be generally referred to as any relevant terminals capable of communication.

For example, the first server 200 may receive video information from the user terminal 100 and provide a video to the client terminal 400. Here, the video information may include visually recognizable data such as a video, etc.

The first server 200 may include a Wowza media server, which supports Adobe real time messaging protocol (RTMP) or open source-based Red5 streaming server, but the type of first server 200 is not limited thereto. A video, such as real-time Internet live broadcasting or Internet broadcasting, may be provided to the viewers using a hypertext transport protocol (HTTP) live streaming protocol which can process streaming without performing DEMUX/MUX for a moving picture container and decoding/encoding for a moving picture codec, or other protocols based on schemes for transmitting a moving picture file over HTTP such as MS smooth streaming, Adobe HTTP dynamic streaming, etc.

The second server 300 may provide the client terminal 400 with the editing information selected by the user. More specifically, the second server 300 may receive the editing information from the user terminal 100, wherein the editing information includes a design frame, images, text, background music, sound effects, subtitles, etc. and contains all effect information, other than the video information provided by the first server 200 to the client terminal 400.

In this case, the editing information may be provided to the second server 300 by another user, other than the user terminal 100 that has provided the video information to the first server 200. However, the present invention is not limited to the above description, and both of the video information and the editing information may be received from the same user terminal 100.

By the configuration described above, in the client terminal 400, the editing information is applied to the video information so that an edited video as desired by a user can be provided in real time to the viewer.

The first and second servers 200 and 300 do not generate a synthesized video through encoding, wherein the synthesized video is made by combining the video information and the editing information provided from the user. The synthesized video in which the editing information is applied to the video information is generated in the client terminal 400.

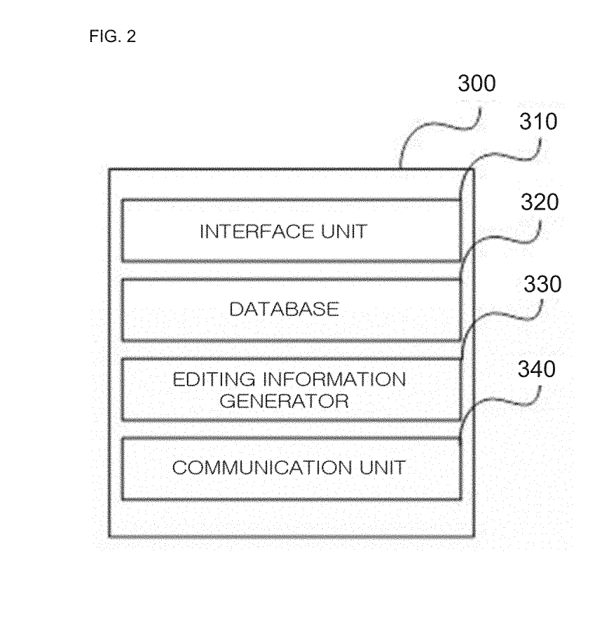

Referring to FIG. 2, which is a block diagram illustrating the second server of the video editing system in accordance with one embodiment of the present invention, the second server 300 includes an interface unit 310, a database 320, an editing information generator 330, and a communication unit 340.

The interface unit 310 provides an interface for exchanging data related to the editing information between the user terminal 100 and the second server 300.

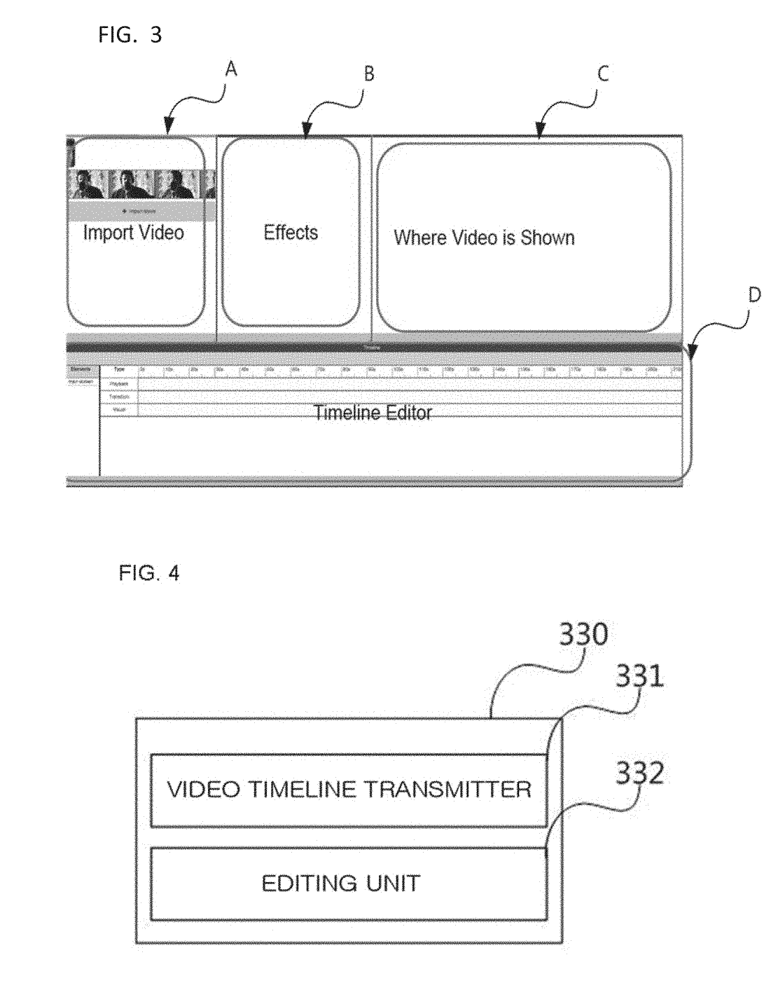

Referring to FIG. 3, which is a diagram illustrating an interface of the video editing system in accordance with one embodiment of the present invention, the interface unit 310 includes, for example, video selection information which may be selected or input by a user through a web-browser or the like that is executed on the user terminal in order to edit the video information to be customized to the user's need.

In this case, the video selection information may include a video selection screen A, an effect application screen B, a preview screen C, a video timeline editing screen D, and the like.

In the video selection screen A, which is to be provided by a user to a viewer, for example, a moving picture file or a list of moving picture files may be placed.

The effect application screen B displays the effect which is selected by a user through the interface unit 310 and is to be applied to the video information.

For example, from the effect application screen B, a user may select effects desired to be applied to the selected video, and the effects may include text input, subtitle insertion, drawing, shape insertion, decorative object insertion, picture-in-picture (PIP) screen processing, screen switching, picture-on-picture (POP) screen processing, a screen switching effect, adjustment of positions of edited objects, layer processing, audio mixing, video signal and audio signal synchronization processing, logo insertion, etc.

In addition, the editing information may include any effects for a design frame, images, text, background music, subtitles, and the like which may be selected or input by a user through the interface unit 310 of the user terminal 100, except the video information.

For example, the design frame may be formed with at least one design and may be included as objects, such as videos, images, or a motion (dynamic images), which are preset for each theme. In addition, the design frame may be a flash-type template which is used as the default background template.

The preview screen C may be a video which displays a result of applying the effect selected from the effect application screen B by a user to the video selected from the video selection screen A.

The video timeline editing screen D displays a video timeline so that various effects may be applied according to the timeline in various ways.

For example, through the video timeline editing screen D, the user may register and apply various desired effects selected from the effect application screen B to the timeline so that the desired effects may be sequentially applied.

In addition, in the interface unit 310, a screen which displays a video to which the editing information provided by the client terminal 400 is applied or an editing screen (not shown) of a plurality of pieces of video information may be provided.

The database 320 may be a storage medium for storing video selection information. The database 320 has a general data structure that is implemented in a storage region (hard disk or memory) of a computer system by a database management program (i.e., DBMS) and may refer to a form of data storage which allows free search (extraction), deletion, edition, and addition of data to be performed. The database 320 may be implemented for the purpose of one embodiment of the present invention using) a relational database management system (RDBMS), such as Oracle, Infomix, Sybase, or DB2, or an object-oriented database management system (OODBMS), such as Gemstone, Orion, O2, etc., and an XML native database, such as Excelon, Tamino, Sekaiju, etc., and may have appropriate fields or elements in order to achieve functions thereof.

Also, the database 320 may store editing information about effects such as text input, subtitle insertion, drawing, drawing, shape insertion, decorative object insertion, PIP screen processing, screen switching, POP screen processing, screen switching, adjustment of positions of edited objects, layer processing, audio mixing, video signal and audio signal synchronization processing, logo insertion, etc.

The editing information generator 330 may generate editing information corresponding to the video selection information selected by a user through the interface unit 310.

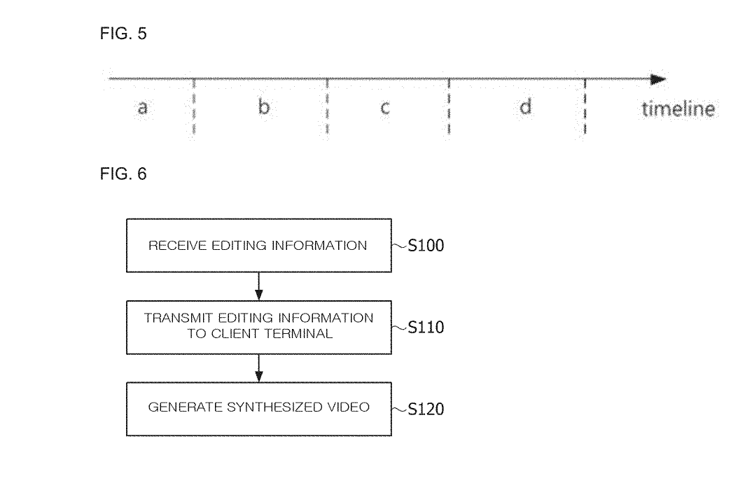

FIG. 4 is a block diagram illustrating an editing information generator of the video editing system according to one embodiment of the present invention. FIG. 5 is a diagram illustrating a timeline according to which the video editing system in accordance with the embodiment of the present invention provides the viewer with different editing effects.

Referring to FIG. 4 and FIG. 5, the editing information generator 330 includes a video timeline transmitter 331 and an editing unit 332.

The video timeline transmitter 331 generates first editing information in the client terminal 400 about order of application of video selection information so that the pieces of video selection information, which are selected by the user through the interface unit 310, can be applied to the video according to the predetermined order.

That is, the video timeline transmitter 331 generates the first editing information which is editing information associated with time.

Accordingly, it is possible to sequentially apply the effects selected by the user to the effect application screen B of the interface unit 310 at desired time points. In addition, it is possible to simultaneously apply a number of effects.

Referring to FIG. 5, the video timeline transmitter 331 may generate first editing information according to which various effects a, b, c, and d are applied in a-b-c-d order.

The editing unit 332 generates second editing information about effects of the video selection information selected by a user through the interface unit 310.

That is, the editing unit 332 may generate the second editing information from the database 320, wherein the second editing information is related to the effects that correspond to the video selection information selected by the user through the interface unit 310.

In this case, the second editing information may be editing information about effects such as text input, subtitle insertion, drawing, drawing, shape insertion, decorative object insertion, PIP screen processing, screen switching, POP screen processing, screen switching, adjustment of positions of edited objects, layer processing, audio mixing, video signal and audio signal synchronization processing, logo insertion, etc.

The editing information including the first editing information and the second editing information may be operated based on OpenGL.

The video editing system 10 in accordance with one embodiment of the present invention is developed based on OpenGL and hence has advantages below:

First, OpenGL is superior in terms of versatility. OpenGL may support any operating system (OS) such as Windows, Linux, Unix, Mac OS, OS/2, BeOS, OSX, mobile platforms such as Android and iOS, etc. That is, the code according to the present invention can be directly integrated into any OS as long as the code is translated as a platform of the pertinent OS.

In addition, OpenGL is a group of libraries that describe a series of execution commands for drawing or special effects and may pre-calculate a series of functions for graphic representation such as removal of hidden surface, transparency, anti-aliasing, texture mapping, pixel control, modeling for transformation, atmospheric effects (e.g., fog, smoke, haze, etc.), and the like. In addition, OpenGL may also include a function for converting numeric data into graphics, which is functionalized as callable subroutines.

Second, OpenGL is superior in terms of scalability. OpenGL which is composed of open codes may easily expand to various fields. The video editing system 10 using OpenGL code in accordance with the present invention may be utilized in various fields such as one-way or two-way Internet broadcasting or Internet live broadcasting through streaming.

In addition, OpenGL has an application programming interface (API) even for portable devices, such as a mobile phone, a portable media player (PMP), and the like, and thus, with some converting, OpenGL may be used in portable devices. Therefore, OpenGL may be considered to be appropriate for the ubiquity era.

The editing unit 332 may generate editing information such that, for example, a video in which one real-time video and another real-time video are combined with each other through PIP screen processing is provided to the client terminal 400 or a video in which a real-time video is combined with a pre-stored video file or a video inserted by the user is provided to the client terminal 400.

In addition, the editing unit 332 may provide the viewer with a plurality of effects as a single effect.

Moreover, the editing unit 332 may generate editing information about 2-dimensional (2D)/3-dimensional (3D) subtitle insertion, subtitle removal, background color, background transparency, text border thickness and color adjustment, effect repetition, text deletion, and the like.

Further, the editing unit 332 may also generate editing information about various types of lines (straight lines, curves, arrows, etc.), figures (circles, ovals, rectangles, rounded rectangles, pentagons, asterisks, etc.), shapes, and colors which are selected and drawn by the user.

In addition, the editing unit 332 may generate editing information corresponding to editing data that corresponds to the video selection information such that design clip art, icons, frames, boards, animations, and 3D objects may be applied to the video.

Moreover, the editing unit 332 may generate editing information which gradually applies an effect corresponding to the video selection information to the video. Also, the editing unit 332 may generate a plurality of pieces of editing information for the respective video information and provide the viewer with various editing effects applied to each video.

The communication unit 340 transmits the editing information generated by the editing information generator 330 to the client terminal 400. The communication unit 340 is a group of resources that form a communication path, as a data communication network, among the user terminal 100, the second server 300, and the client terminal 400 and may include a local area network (LAN), Universal Serial Bus (USB), Ethernet, power line communication (PLC), wireless LAN, code division multiple access (CDMA), time division multiple access (TDMA), frequency division multiple access (FDMA), wireless broadband Internet (WiBro), long term evolution (LTE), high speed downlink packet access (HSDPA), wideband CDMA, ultra-wideband (UWB), ubiquitous sensor network (USN), radio frequency identification (RFID), infrared data association (IrDA), near field communication (NFC), ZigBee, etc.

The client terminal 400 may apply the editing information received from the second server 300 to the video information received from the first server 200 and provide a viewer with a synthesized video to which the effect selected by a user is applied.

For example, the client terminal 400 receives the editing information which is driven by OpenGL and generates the synthesized video by applying the editing information selected by a user to the corresponding video information.

In this case, the client terminal 400 may generate and reproduce the synthesized video using OpenGL that may be applied to various types of mobile devices including a smartphone, a tablet computer, a laptop, a PDA, an electronic frame, a desktop PC, a digital TV, a camera, and a wearable device such as a wristwatch and an HMD.

However, the application of the client terminal 400 is not limited to the above examples and may be referred to as any relevant terminals capable of communication.

As described above, by using the video editing system 10 in accordance with the embodiments of the present invention, video synthesis is performed in the client terminal 400 without receiving a synthesized video in which the editing information and the corresponding video information are encoded so that the selection of the user terminal 100 is provided to the client terminal 400 in real time, and hence the user can receive an instant response from the client.

In addition, by using the video editing system 10 in accordance with the embodiments of the present invention, viewers can be easily provided with editing effects selected by a user even in a native environment of the client terminal 400 with low-performance specifications.

Referring to FIG. 6, which is a flowchart illustrating a video editing method according to one embodiment of the present invention, a second server receives editing information that corresponds to video information provided from a first server to a client terminal (S100). In this case, the first server receives the video information, and the second server receives editing information that is selected by a user and includes any effects for design frame, images, text, background music, subtitles, and the like of the video, other than video information. As described above, the video information and the editing information may be received from the same user or from each of different users. In addition, at least a part of video information and editing information may be received from a plurality of users.

The video information and the editing information may not be encoded in either the first server or the second server and may be separately transmitted.

Then, the editing information is transmitted to a client terminal (S110). The first server and the second server transmit video information selected by client and editing information corresponding to the selected video information to each of a plurality of client terminals.

Thereafter, the client terminal receives both of the editing information from the second server and the video information corresponding to the editing information from the first server and applies the editing information to the video information to generate a synthesized video (S120).

In this case, the synthesized video in which the editing information selected by the user is applied is driven by OpenGL in the client terminal so that editing effects are applied in real time to video streaming transmitted from the client and hence provided to the client.

Accordingly, a dynamic editing result can be achieved, and information can be more promptly transmitted between the user and the client so that smooth communication between the user and the client can be established. Thus, it is possible to provide a platform which provides a video and multimedia more promptly.

A video editing system and method according to one embodiment of the present invention may provide a viewer with editing information and video information of a video without an encoding process. Therefore, it is possible to improve productivity of an editing control process.

In addition, various editing effects, such as freely inserting of text and background music, are provided to the viewer, thereby enabling the viewer to use various contents and providing a user with high accessibility for video editing.

Furthermore, editing information is generated based on OpenGL, and hence it is possible to provide a viewer with superior application versatility to any OS and various graphic effects and provide a user with improved scalability of application to various fields.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

### REFERENCE NUMERALS

10: VIDEO EDITING SYSTEM
100: USER TERMINAL
200: FIRST SERVER
300: SECOND SERVER
310: INTERFACE UNIT
320: DATABASE
330: EDITING INFORMATION GENERATOR
340: COMMUNICATION UNIT
400: CLIENT TERMINAL

What is claimed is:

1. A video editing system comprising:
a second server configured to transmit editing information, which corresponds to video information provided from a first server to a client terminal, to the client terminal,
wherein the editing information is applied to the video information in the client terminal.

2. The video editing system of claim 1, wherein:
the editing information is driven by OpenGL in the client terminal; and
a synthesized video in which the editing information is applied to the video information is generated in the client terminal.

3. The video editing system of claim 2, wherein the video information and the editing information are provided from either the first server or the second server to the client terminal without encoding.

4. The video editing system of claim 1, further comprising a user terminal configured to provide the editing information.

5. The video editing system of claim 1, wherein the second server comprises an interface unit configured to provide a user terminal with video selection information for editing the video information.

6. The video editing system of claim 4, wherein the video selection information provided from the second server to the user terminal for editing a video to be customized as desired by a user comprises at least one of a video selection screen, effect application screen, a preview screen, and a video timeline editing screen.

7. The video editing system of claim 6, wherein the video timeline editing screen displays a timeline of the video information.

8. The video editing system of claim 7, wherein effects selected in the effect application screen are applied to the timeline of the video information.

9. The video editing system of claim 8, wherein the selected effects are sequentially applied according to the timeline of the video information.

10. The video editing system of claim 5, wherein the second server further comprises:
an editing information generator configured to generate editing information corresponding to the video selection information selected through the interface unit; and
a database configured to store the video selection information.

11. The video editing system of claim 10, wherein the editing information generator comprises:
a video timeline transmitter configured to provide first editing information about order of video selection information; and
an editing unit configured to provide second editing information about an effect of the video selection information.

12. The video editing system of claim 11, wherein the second editing information in the editing unit gradually applies the video selection information to the video information.

13. The video editing system of claim 11, wherein the second editing information in the editing unit inserts the video information into a predetermined video.

14. The video editing system of claim 1, wherein the video information includes visually recognizable data.

15. The video editing system of claim 1, wherein the editing information is applied to the video information in real time.

16. A video editing method comprising:
receiving, at a second server, editing information corresponding to video information provided from a first server to a client terminal;
transmitting the editing information to the client terminal; and
generating, at the client terminal, a synthesized video in which the editing information is applied to the video information.

17. The video editing method of claim 16, wherein:
the editing information is driven by OpenGL in the client terminal; and
the synthesized video in which the editing information is applied to the video information is generated in the client terminal.

18. The video editing method of claim 17, wherein the video information and the editing information are provided from either the first server or the second server to the client terminal without encoding.

19. The video editing method of claim 16, wherein the video information includes visually recognizable data.

20. The video editing method of claim 16, wherein the editing information is applied to the video information in real time.
